(19) United States
(12) Patent Application Publication
(10) Pub. No.: US 2014/0172610 A1
(43) Pub. Date: Jun. 19, 2014

(54) ACCOUNT-BASED CHECKOUT

(71) Applicant: BOOPSIE, INC., Laguna Beach, CA (US)

(72) Inventors: G. Gregory Carpenter, Laguna Beach, CA (US); Timothy L. Kay, Los Altos, CA (US)

(73) Assignee: BOOPSIE, INC., Laguna Beach, CA (US)

(21) Appl. No.: 13/719,185

(22) Filed: Dec. 18, 2012

(51) Int. Cl. G06Q 20/40

(52) U.S. Cl. CPC G06Q 20/40
USPC 705/26.1

(57) ABSTRACT

The present invention leverages the account-creation process that necessarily precedes any account-based transaction. The process of creating an account is enhanced to include the pre-association of various “ID Factors” that can be employed in combination to identify that account. Permitted combinations of ID Factors are those that comply with the account provider's security policy. Subsequently, at the time of a transaction in which a customer desires to check out items, the customer need only present an acceptable combination (i.e., one which meets the provider's security policy) of the ID Factors which have been pre-associated with the customer's account. In one embodiment, such an account-identification mechanism is coupled with a product-identification mechanism to enable a flexible and secure automated self-checkout system.

### FIELD OF ART

This application relates generally to transactional checkout systems and processes, and in particular to checkout systems and processes for account-based transactions between providers of goods and services and their customers.

### DESCRIPTION OF RELATED ART

While online transactions have seen exponential growth in recent years, physical “brick and mortar” institutions have been forced to adapt in order to provide some of the same conveniences online customers rely upon and have come to expect. A streamlined and more automated checkout process is one such convenience. While online customers often breeze through the checkout process with a few mouse clicks, particularly after having set up an account with a particular provider, brick and mortar customers face additional obstacles that require greater human interaction. This is particularly true in the context of account-based transactions in which a customer's account must be identified and associated with the items being checked out, in addition to any required payment mechanism (cash, credit card, etc.).

With the advent of “product identifiers” such as barcodes and RFID tags, many retail outlets now routinely employ “scanners” to identify the items being checked out or purchased by customers, thereby facilitating a more automated checkout process. Large grocery chains, warehouse outlets, airlines and a host of other providers of goods and services have adopted these systems for typical retail transactions in which only a payment mechanism is required. Such systems have also been used for account-based transactions (e.g., checking out books from a library), though it should be noted that these systems tend to identify only the items being checked out, and not a customer account with which those items must be associated.

Another obstacle to a a more automated “self-checkout” process is the need for verification that the items in the customer's possession have in fact been checked out. Libraries, for example, have long used “tattle-tapes” or other types of magnetic strips embedded in books to streamline the checkout process while minimizing theft. Mechanisms for degaussing or changing the magnetic “state” of the strip, coupled with a security gate that detects the strip's “checkout state” and conditionally sounds an alarm based upon that state, provide a secure method for verifying the items being checked out.

More recently, RFID tags have exploded in popularity, and are quickly becoming the de facto standard product identifier. RFID tags typically contain a “security bit” that can be cleared, for example, to alter the “checkout state” of an item, which can then be detected by a security gate, with an alarm triggered if an item has not been checked out properly and had its security bit cleared.

Despite these solutions to product identification, additional obstacles to a fully-automated self-checkout process remain, particularly in the context of account-based transactions in which the provider must not only identify the items being checked out, but must also associate those items with a customer's account. In a typical retail scenario, a payment mechanism, such as a credit card, is all that is required. In an account-based transaction, however, such as the checkout of books from a library, the provider must associate the books being checked out with the patron's library account. This is typically accomplished today with a library card, or some other “account-specific” identifier. Some retailers also provide such account-specific identifiers, for example, via an “affinity” card used for account identification, and sometimes also as a payment mechanism.

While there are various automated solutions to this “account identification” problem, the current solutions have consequences that have thus far limited their effectiveness. One of the most significant consequences is the inconvenience of having to carry a separate card or other account identifier for each account-based provider. For example, libraries can provide each patron with a library card containing a barcode or RFID tag, but anyone who does not have their library card with them (or memorized their library account number, and perhaps an associated security “pin”), cannot check out books—or at least not without the assistance of a librarian. Moreover, the cost of providing such cards (e.g., RFID-based cards) to every customer can be prohibitive.

The widespread adoption of mobile phones has led some providers (e.g., Starbucks) to accept barcodes displayed on a customer's mobile phone as a form of identification of the customer's account. While this form of account identification is more convenient than having to carry a physical account card (or multiple different cards), the customer is still restricted to a single form of account identification that is “account specific”—i.e., it is designed for the purpose of identifying that particular account, as opposed to another “unaffiliated” account (e.g., one from another provider).

Different providers might therefore adopt different solutions. Some might scan RFID tags or employ “NFC” or near field communications, currently available on some mobile phones. It should be noted, however, that even such mobile phones typically cannot clear the security bit of an item's RFID tag, rendering existing security gates useless. Others might adopt non-phone solutions such as RFID cards or web-based account names/passwords that customers input into a checkout device. Even the ultimate adoption of an industry-standard identifier (e.g., Google Wallet or Apple Passbook) would require each person to carry that form of identification.

While the elusive search for the “universal identifier” continues, there remains a need for a flexible account-identification mechanism and process that, when integrated with product-identification, enables customers to checkout items to their account with minimal or no human intervention, and without restricting providers from imposing whatever security policy they desire.

### SUMMARY

To address the concerns noted above, one embodiment of the present invention leverages the account-creation process that necessarily precedes any account-based transaction. The process of creating an account is enhanced to include the pre-association of various “ID Factors” that can be employed in combination to identify that account. Permitted combinations of ID Factors are those that comply with the account provider's security policy. Subsequently, at the time of a transaction in which a customer desires to check out items, the customer need only present an acceptable combination (i.e., one which meets the provider's security policy) of the ID Factors which have been pre-associated with the customer's account. In one embodiment, such an account-identification mechanism is coupled with a product-identification mechanism to enable a flexible and secure automated self-checkout system.

It should be noted that the pre-association of ID Factors need not occur at the moment a customer's account has been created. For example, in another embodiment, customers are free to register (or modify previously registered) ID Factors at any time prior to the use of such ID Factors in an account-based transaction. In yet another embodiment, the association of certain ID Factors is implicit (e.g., via a provider policy that automatically accepts particular ID Factors).

In one embodiment, a self-check kiosk is employed to scan each item's embedded RFID tag. Customers identify their account by presenting any permitted combination of pre-associated ID Factors, which can be scanned automatically or, in another embodiment, be verified manually. In a library scenario, for example, a patron places books with embedded RFID tags onto a kiosk which, upon verifying the patron's account, clears the security bit of each book's RFID tag, indicating that the book has been checked out.

One patron might register a library card and an associated 4-digit pin. Another patron might register a barcode generated by a mobile phone (via any app “trusted” by the library), while another might register an RFID or NFC “tag” generated by one of the mobile phones currently on the market having that capability. Still another patron might register a car key containing an RFID tag. The list is virtually endless, providing extensive flexibility to library patrons, while enabling libraries to impose a security policy that accomodates such flexibility, subject only to the capability of the library's “scanning” equipment (and the availability of librarians to the extent manual steps are required).

The checkout process is completed by contacting a remote database (e.g., the ILS or Integrated Library System) to update the customer's account and associate the checked-out books with that account. In one embodiment, the kiosk performs this step automatically, while in another embodiment a librarian employs a computer to complete this process.

In yet another embodiment, the patron utilizes a mobile phone to perform the checkout process for each book. In a variation of that embodiment, the mobile phone need only be employed for one book (i.e., to identify the customer's account), and the kiosk relied upon to complete the process by scanning the RFID tag of all the books being checked out, providing this information to the ILS, and clearing the security bit of each RFID tag.

In each of the embodiments described above, an existing security gate can be leveraged to verify that the security bit of each item's RFID tag has been cleared, and thus that each item has been properly checked out. In alternative embodiments, patrons can perform the checkout process as described above, but without the assistance of a self-check kiosk to clear the security bit of each book's RFID tag. For example, as noted above, a patron's mobile phone may be capable of scanning a book's RFID tag, but incapable of clearing its security bit.

In these embodiments, an existing security gate is enhanced to scan each book's serial number and query the ILS database to verify that the books have been properly checked out (i.e., ignoring whether the security bit of each book's RFID tag has been cleared). To speed up this process and allow for an alarm to sound (in the event of a discrepancy) before the patron leaves the premises, other embodiments of the security gate scan only a portion of the serial number, and rely upon a second database (synced to the ILS) to verify that the books have been properly checked out. Moreover, if a book has not been properly checked out, the security gate can simply contact the ILS to complete the checkout process.

The pre-association of a customer's ID Factors with the customer's account facilitates a more flexible and automated (perhaps fully automated) checkout process. It should be noted in particular that ID Factors can include forms of identification from other unaffiliated accounts—i.e., those not otherwise associated with the particular provider involved in an account-based transaction. For example, library patrons could use a drivers license or a Starbucks or other “membership” card (perhaps coupled with a pin or other ID Factors) to identify their library account. Such unaffiliated account identifiers are nevertheless sufficiently secure from the library's perspective due to their prior association with the patron's library account.

Customers not only gain the flexibility of selecting from among a wide variety of different pre-associated ID Factors, but also incur significant added convenience as a result of the ability to leverage existing technology that makes use of such ID Factors during the checkout process. For example, in one embodiment, customers simply place their phone or wallet on a scanner, or even leave it in their pocket within proximity of the scanner (e.g., via Bluetooth, WiFi, NFC, etc.). The system automatically identifies the customer's account, as well as the items placed on the scanner, thereby faciliting a fully automated checkout process requiring little or no human intervention.

Moreover, relatively inexpensive hardware (e.g., a tablet such as an iPad, Xoom, etc.) makes this solution particularly desirable, coupled with the ability to leverage a library's existing computing technologies (Ethernet, WiFi, Bluetooth, USB, etc).

As will be described in greater detail below, the present invention can accommodate a variety of embodiments of ID Factors, security policies, and product and account scanning mechanisms and processes, and can be applied to account-based transactions across numerous industries.

### BRIEF DESCRIPTION OF DRAWINGS

FIG. 1 illustrates an architecture of an existing checkout system for account-based transactions, in which a form of account-specific identification is required.

FIG. 2 illustrates an architecture of one embodiment of a checkout system of the present invention for account-based transactions, in which multiple combinations of pre-approved ID Factors associated with a customer's account may be employed.

FIG. 3 illustrates one embodiment of a self-checkout process of the present invention in which a kiosk scans not only the items being checked out, but also various pre-associated ID Factors that, in combination, identify a customer's account.

FIG. 4 illustrates another embodiment of a self-checkout process of the present invention in which a security gate confirms with an external database that each item has in fact been checked out to a customer's account.

### DETAILED DESCRIPTION

### A. General Architecture

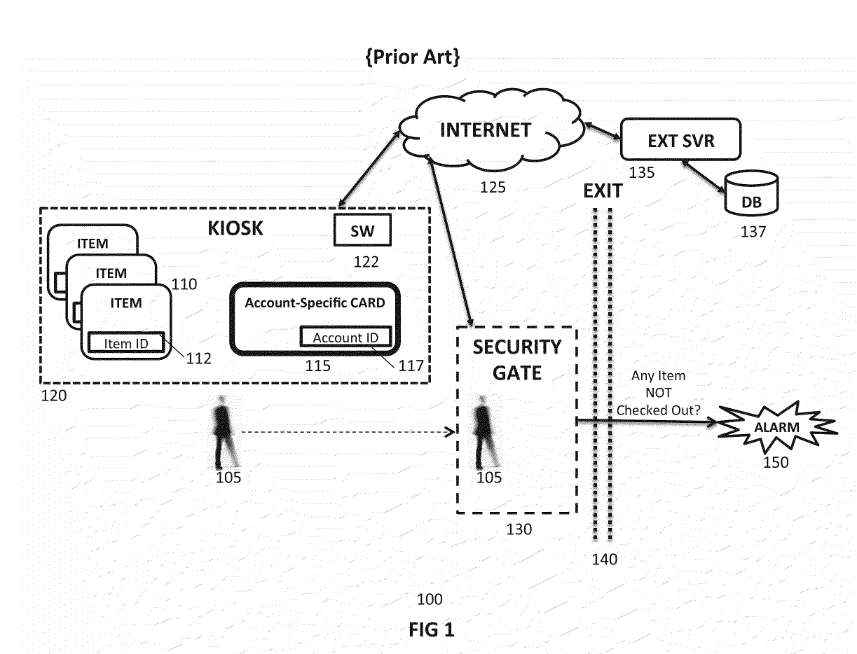

FIG. 1 illustrates an architecture 100 currently in use for account-based transactions, such as those involving checking out books from a library. A library patron 105, after locating one or more books 110, each containing an ID 112 (such as a barcode or RFID tag), places these books 110 on a kiosk 120 (including, for example, a barcode or RFID scanner) for checkout to the patron's library account.

In most libraries, the checkout process requires manual intervention from a librarian, though some libraries have equipped their kiosks 120 with the capability of scanning a patron's library card 115 (containing an account ID 117, such as a barcode, RFID tag, etc), or added a separate scanner for that purpose. As noted earlier, should the patron not remember to bring this “account-specific” library card 115 (or memorize ID 117), the “self-checkout” process may well be interrupted and require manual intervention—assuming checkout is still possible.

A librarian typically will complete the checkout process by contacting an external server 135, which accesses a database 137, such as the industry-standard ILS (Integrated Library System). This is generally accomplished via a computer (not shown separately) connected to the Internet 125 (or, alternatively to a LAN or other network) which transmits the IDs 112 of each book 110 being checked out, along with the patron's account identifier 117. In some cases, as is illustrated in FIG. 1, this computer is integrated into kiosk 120, and controlled via software 122, which facilitates an automated “self-checkout” process that requires no manual intervention from a librarian.

The final step of this checkout process involves changing the “checkout state” of each of the books 110 being checked out. For example, kiosk 120 can clear a “security bit” in the ID 112 of each book 110 (or degauss a barcode or otherwise change the state of book 110 to a “checked out” state).

Having completed the checkout process, the patron 105 proceeds toward the Exit 140, first passing through security gate 130, which scans the IDs 112 of the checked-out books 110, and examines their checkout state. If security gate 130 detects any ID 112 that is not in the “checked out” state, it will typically sound an alarm 150, requiring the patron 105 to repeat the checkout process (and thereby preventing books from leaving the library without being properly checked out to a patron's account).

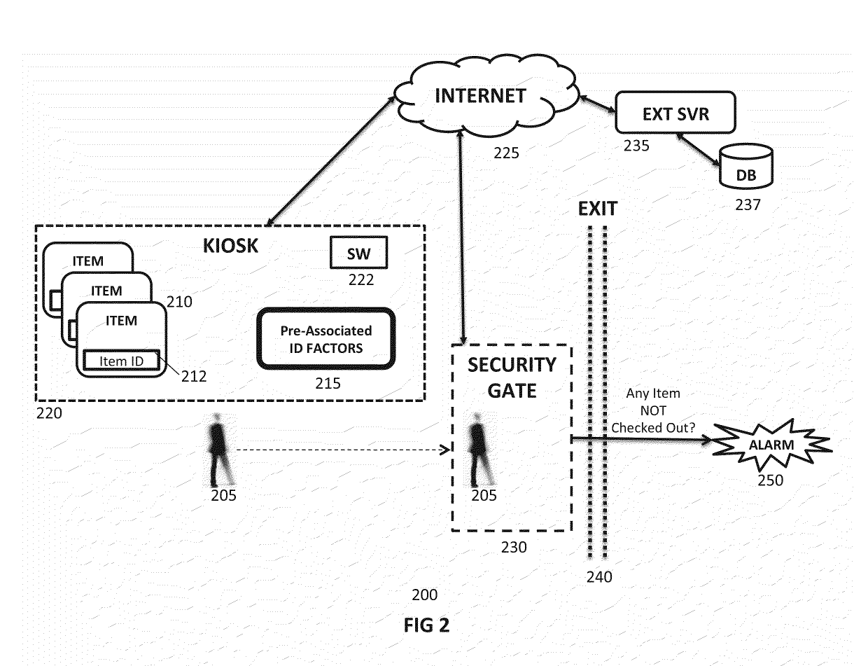

Turning to FIG. 2, which illustrates one embodiment of an architecture 200 of a checkout system of the present invention, the advantages of the present invention can be illustrated in a similar scenario of checking out books from a library. Here too a library patron 205 locates one or more books 210, each containing an ID 212 (such as a barcode or RFID tag), places these books 210 on a scanner in kiosk 220 for checkout to the patron's library account.

However, instead of requiring patrons to carry a library card or other account-specific identifier, a patron 205 can present any combination of pre-associated ID Factors 215 that satisfies the library's security policy. These ID Factors can be registered at the time the customer's account is created, and can be changed and supplemented over time. A new customer could even create an account upon the first use of one or more ID Factors, i.e., creating an account and registering one or more ID Factors simultaneously during an initial checkout process.

The list of potential ID Factors 215 is virtually limitless. Some customers might register account-specific ID Factors, such as a library card (RFID, barcode, etc) or their mobile phone, which can display the account barcode or even utilize NFC (near-field communication technology, a form of RFID).

Yet, these account-specific ID Factors are not required. Issuing RFID cards to every customer can be quite expensive. Instead, permitting customers to register items that they frequently have in their possession is a significant added convenience, particularly when multiple ID Factors can be registered such that no particular one is necessarily required.

For example, a customer's drivers license or car key could be an ID Factor, particularly ones with an embedded RFID tag that could be read by a provider's scanner. It should be noted that an ID Factor's ability to be scanned automatically is a significant convenience (e.g., for a more automated self-checkout), but not an absolute requirement. The flexibility afforded by enabling customers to present pre-associated ID Factors can still be achieved. While a customer might normally have their drivers license or car key in their possession, the convenience of having alternative ID Factors cannot be overestimated.

Moreover, ID Factors need not be unique. A provider's security policy can require combinations of factors, such as a supplemental 4-digit “pin” number, in addition to other ID Factors. A customer might also desire to use one or more credit cards as an ID Factor, even when no payment is required (e.g., to check out library books). Yet, such a credit card could also be used as payment mechanism—e.g., to pay library fines. It should be noted that many RFID scanners cannot read a credit card's RFID tag, unlike certain NFC-enabled mobile phones. Thus, a customer could utilize such a mobile phone, coupled with a credit card, to perform the checkout process (e.g., scanning the customer's credit card to verify the account, and even contact an external database such as the ILS to check out books, and even pay a library fine).

Other unaffiliated ID Factors include biometric data, such as facial recognition, fingerprints, iris scans, etc. A scanner might even include a camera or other sensor to recognize a customer, and thus identify the customer's account. It should be emphasized that, while biometric factors are not currently commonplace due to the expense of achieving highly accurate results, such factors can be quite valuable as one of many ID Factors. For example, facial recognition can be implemented with today's technology quite inexpensively (e.g., using a smartphone camera and an associated software app), though not necessarily with a high degree of accuracy. Yet, when coupled with other ID Factors, such as a car key or 4-digit pin, the level of accuracy rises exponentially, and may well satisfy many providers' security policies.

In addition to the flexibility of choosing from among a large number of potential ID Factors, including unaffiliated ones, the logistics of certain ID Factors can also provide added convenience. For example, with RFID/NFC technology, proximity may be sufficient. Customers might simply place their wallet or car keys on a scanner, or even perhaps leave them in their pocket. Mobile phones can be “bumped” or touched to a scanner, or simply be nearby, perhaps after launching a particular smartphone app.

While barcode and RFID scanners are improving in accuracy, they are not perfect, and can frequently misscan one or more items. Yet, given the ability of a customer to utilize a mobile phone to identify the customer's account, that phone can also be used to scan one or more items being checked out. In one embodiment, a customer could scan a single item (to identify the customer's account and associate it with the items being checked out), leaving an RFID scanner to “do the heavy lifting” of scanning the remaining items. If an item is missed, the customer can utilize the mobile phone to scan the item, or even enter the item's ID into the phone, which can then communicate with an external server to facilitate the checkout process.

Because ID Factors are employed to identify the customer's account, any misscanned items can easily be “rescanned” (by whatever means) and still be associated with the customer's account. The ability to utilize a wide variety of ID Factors, including those that are not specific to the customer's account, and may not even constitute a typical form of ID, provides significant convenience to customers. By pre-associating such ID Factors with the customer's account, a provider can accept forms of “ID” that they didn't even know existed, and yet retain the ability to control the security policy that determines which ID Factors and combinations thereof are permitted or authorized as a form of identifying their customers' accounts.

In one embodiment, scanner 220, controlled via software 222, completes the checkout process by contacting external server 235, which accesses ILS database 237 via the Internet 225. Scanner 220 transmits the IDs 212 of each book 210 being checked out, along with the patron's account identifier (not shown) discerned from ID Factors 215. As noted above, this capability can be integrated into scanner 220 or provided by a separate computer, and can be fully automated or operated with the assistance of a librarian or other support personnel. Moreover, a LAN or other network could be utilized as an alternative to the Internet 225.

Once again, the final step of the checkout process involves changing the “checkout state” of each of the books 210 being checked out. In one embodiment, scanner 220 clears the security bit in the RFID 212 of each book 210. In other embodiments, it can degauss a barcode or otherwise change the state of each book 210 to a “checked out” state.

Having completed the checkout process, the patron 205 proceeds toward the Exit 240, first passing through security gate 230, which scans the IDs 212 of the checked-out books 210, and examines their checkout state. If security gate 230 detects any ID 212 that is not in the “checked out” state, it sounds an alarm 250, requiring the patron 205 to repeat the checkout process.

This architecture enables providers to leverage existing scanner and security gate technology, as well as existing infrastructure, such as RFID tags, tattle tapes or barcodes embedded in each book. Moreover, relatively inexpensive devices, such as an iPad or Xoom tablet, can be employed to implement the enhanced capabilities of interacting with patrons, verifying a provider's security policy against pre-associated ID Factors and communicating with the ILS or other external servers and databases.

As will be discussed in greater detail below with respect to other embodiments of the present invention, portions of the checkout process, including communication with external servers, can be shared between the scanner and the security gate. For example, in one embodiment, the scanner recognizes the pre-associated ID Factors, as well as the items being checked out, associates those items with the customer's account, and modifies the checkout state of each item, thereby enabling existing security gate technology to be employed to verify that each item has been properly checked out.

Yet, in another embodiment, the customer employs a mobile phone to identify the customer's account and check out one or more of the items. In this embodiment, a scanner need not even exist, as it does not rely on the modification of the checkout state of each item (e.g., clearing an RFID security bit). Instead, the security gate is enhanced, upon recognizing that an item does not appear to have been checked out (e.g., its RFID security bit has not been cleared) to contact an external server and verify that the user has properly checked out such items. Moreover, even if an item has not been checked out, the customer can complete the “self-checkout” process at the enhanced security gate without requiring any additional human intervention.

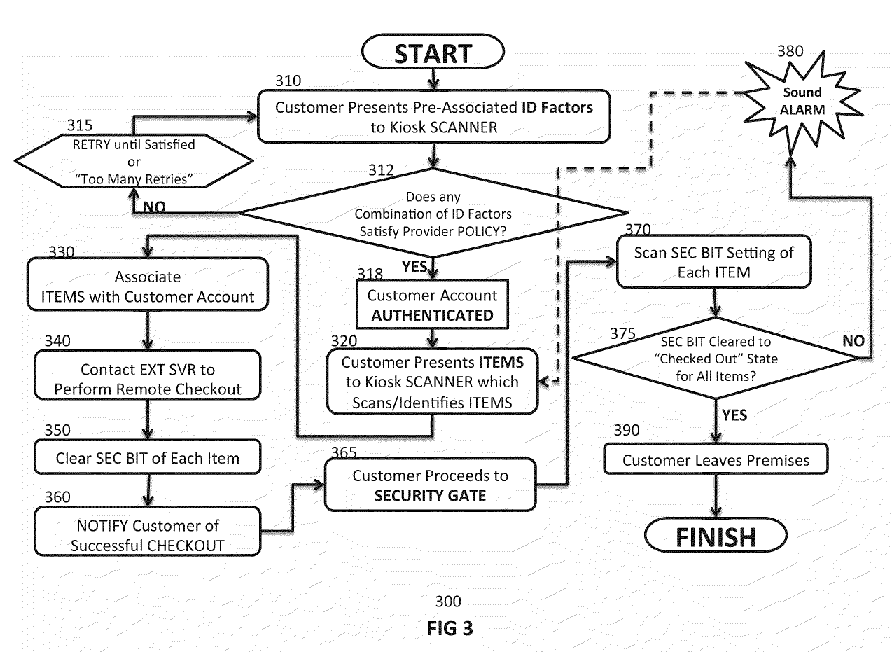

Turning to FIG. 3, the process of one embodiment of a self-checkout process 300 of the present invention is illustrated. In this embodiment, after gathering items to be checked out, a customer initially presents (in step 310) one or more pre-associated ID Factors to a kiosk scanner, which automatically scans these ID Factors in order to identify the customer's account. Though not shown, step 310 can be repeated until sufficient ID Factors have been scanned to identify the customer's account (or the process times out or otherwise ceases operation, in which case manual assistance may be required).

In this embodiment, all of the ID Factors can be scanned automatically (e.g., via a barcode or RFID/NFC scanner). In other embodiments, a user might interact with the kiosk, including for example an iPad tablet, to enter a pin or other ID Factor. In still other embodiments, manual identification of one or more ID Factors may be necessary with the assistance of a checkout clerk.

Turning to step 312, the provider's security policy is measured against the scanned ID Factors to determine whether any combination of those ID Factors satisfies the provider's security policy. If no permitted combination is identified, the process, including step 310, is retried (in step 315) until it either completes successfully (i.e., satisfies step 312) or times out or otherwise ceases operation.

Once the customer account is identified and authenticated in step 318, the customer presents the items to be checked out to the kiosk scanner in step 320. After each item is scanned and identified, these items are associated with the customer's account in step 330. This information is then transmitted to an external server, which performs this remote checkout.

In one embodiment involving the checkout of books from a library, this external server records the checkout in the ILS database. The kiosk iPad includes an app to contact the ILS server and transfer information including the customer's account identifier and identifying information for each book to be checked out.

In this embodiment, each item is a book containing an RFID tag with a security bit that is cleared in step 350 to indicate that the book has been checked out. The app notifies the customer in step 360 of a successful checkout (e.g., by displaying such a notice on the iPad screen, along with information regarding each book—e.g., title, author, checkout duration, etc.).

The customer then proceeds in step 365 to the security gate which, in step 370, scans the security bit of the RFID tag in each item/book and verifies, in step 375, whether each such book was in fact properly checked out. For example, if the kiosk did not clear the security bit in the RFID tag in one or more books, then the gate sounds an alarm, in step 380 (e.g., to prevent the customer from leaving the premises with a book that has not been properly checked out). In this case, the process returns to step 320 to permit the customer to rescan the items that have not been properly checked out.

Once the security gate verifies, in step 375, that all security bits have been cleared, and thus that all of the books have been properly checked out, the customer is permitted to leave the premises in step 390 (i.e., because no alarm sounds). In one embodiment, a green light could alight to indicate that the process has been successful and that the customer may leave the premises. In another embodiment, a “successful checkout” message could be integrated into the security gate.

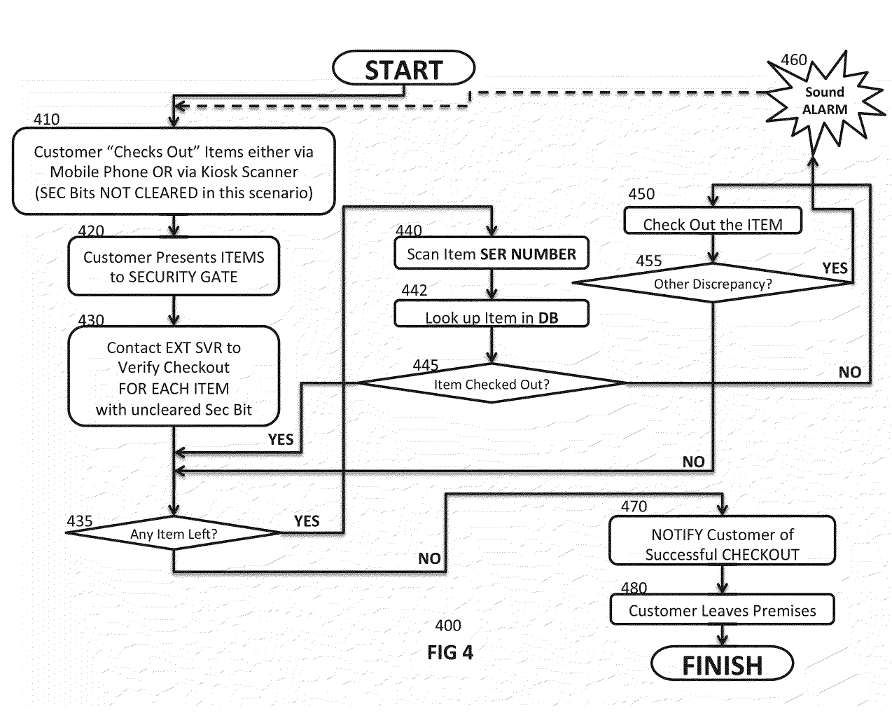

As an alternative to enhancing existing kiosks to identify the customer's account (as well as contact the ILS or other remote server), FIG. 4 illustrates another embodiment of a self-checkout process 400 of the present invention in which existing security gate functionality is enhanced to perform many of these steps, in addition to verifying that items have been properly checked out.

In one embodiment, a customer (such as a library patron) checks out items in step 410 directly from the customer's own mobile phone. For example, an app on the phone enables the customer to authenticate the customer's account, update a remote database such as the ILS, and associate one or more books with that account, effectively “checking them out.” The item identifiers (e.g., in barcodes or RFID tags) can be scanned via the mobile phone app. Alternatively, the customer can enter the relevant information manually.

Note, however, that, without a traditional kiosk scanner, the customer may not be able to change the checkout state of the items (e.g., clearing an RFID security bit). In other embodiments, a traditional kiosk scanner may be employed not only to scan one or more items, but also to clear the security bit (or degauss a magnetic strip, etc). In another embodiment, ID Factors may be employed with an enhanced kiosk, such as the one discussed above with respect to FIG. 3, to perform virtually all of these steps.

As a result of step 410, however, one or more items may be “checked out” from the perspective of the remote database, but without having its “checkout state” altered (e.g., by clearing its RFID security bit). So, a traditional security gate might still sound an alarm once it detects that one or more items do not appear to have been properly checked out.

In this embodiment, the customer nevertheless proceeds in step 420 to an enhanced security gate with additional functionality to address this potential problem. The security gate first scans the security bit of the RFID tag of each item (or barcode) to determine whether any item does not appear to have been properly checked out (i.e., its security bit has not been cleared).

With respect to each such item, the security gate contacts the external server (e.g., ILS) in step 430 to verify whether that item has in fact been checked out, despite the checkout state of its identifier. In one embodiment, the security gate scans ID Factors (as discussed above) to identify the customer's account. In other embodiments, the security gate may be aware of only the ID of each book, but not of the customer's account.

The security gate in step 435 determines whether one or more such items remains to be verified. If so, it then scans that item's serial number in step 440, looks up the item in the remote database in step 442, and verifies in step 445 whether the item has been checked out. If the item has in fact been checked out, then control returns to step 435 to repeat this process for the next such item.

If an item has not been properly checked out (per the remote database), then the security gate, if it is aware of the customer's account (e.g., via scanned ID Factors), can simply check out the item in step 450 because it is in contact with the remote server. If, however, it is not aware of the customer's account, or there is another discrepancy preventing a proper checkout (determined in step 455), then an alarm is sounded in step 460.

For example, an item's serial number may not be found, the customer's account may not have been properly identified, or some other problems may exist with the customer's account (e.g., unpaid late fees). Moreover, until one item has been successfully checked out, the security gate may not be able to verify the customer's account. It may also be possible that multiple customers proceed through the security gate at the same time, and that each book cannot necessarily be associated with a particular customer's account.

In the event of any such discrepancies, after sounding the alarm in step 460, the customer can return to step 410 to repeat the checkout process, perhaps receiving manual assistance from a staff member. As noted above, the security gate could include additional functionality supporting ID Factors which would facilitate identification of the customer's account and perhaps alleviate certain discrepancies.

Assuming no such discrepancies are found in step 455, control returns to step 435 to repeat this process for the next such item. Once it is determined in step 435 that all such items have been processed (i.e., all items have been verified as properly checked out, either via their security bit or via a remote database), then the customer is notified in step 470 that the checkout process was successful, and proceeds to leave the premises in step 480.

It should be noted, however, that the process of proceeding through a security gate is normally a very quick one. It is therefore important that the customer not simply leave the premises before proper checkout of each item can be verified, and an alarm sounded if necessary.

Two speed-related problems may therefore need to be considered to address this concern. For example, reading an item's serial number can take significantly more time than simply examining an RFID security bit. Moreover, contacting a remote database such as the ILS to verify that an item has been checked out can also take significant time.

In one embodiment, these concerns are addressed by reading only a small portion of the serial number. Though this approach may not technically provide a unique identification of an item, it is likely to be sufficient in most cases, and well worth the tradeoff of the additional time required in those relatively few cases when a problem occurs.

To speed up the process of accessing the ILS or another relatively slow remote database, a secondary database (synced to the ILS or other “primary” database) can be employed. A modern database can reside entirely in RAM (or in SSD or another relatively fast storage medium), providing significantly faster access times. This secondary database can be modified by the mobile phone app whenever the app checks out an item to the primary database. If an item has been checked out via a traditional kiosk scanner, and had its security bit cleared, there is no need for the secondary database to be updated, as the security gate will verify the item as having been checked out once it detects the cleared security bit.

It should be noted that the use of ID Factors to facilitate identification of a customer's account can be employed in a variety of different embodiments, including those discussed above, with the functionality present in a kiosk scanner, security gate or other device, as well as combinations of the above. Once a customer's account is identified, existing item identification mechanisms can be leveraged, linking checked-out items to a customer's account and facilitating a more automated self-checkout process.

1. A method for checking out a plurality of items to a customer's account with a provider of goods and services, each item including an item identifier, the method including the following steps:
(a) creating a customer account with a provider;
(b) associating one or more ID Factors with the customer account, including an ID Factor not otherwise affiliated with the customer account, wherein one or more combinations of the ID Factors facilitates identification of the customer account in accordance with a security policy of the provider;
(c) authenticating the customer account at the time of an account-based transaction at the physical premises of the provider, by recognizing one or more ID Factors presented by the customer, and verifying that at least one combination of those ID Factors satisfies the provider's security policy;
(d) recognizing the item identifier of one or more items to be checked out to the customer account, and associating those items with the authenticated customer account;
(e) altering the checkout state of each of the items to indicate that each item has been checked out; and
(f) verifying the checkout state of each item as the customer passes through a security gate before leaving the provider's premises, and sounding an alarm in the event that the checkout state of one or more items does not indicate that the item has been checked out.
